(19) United States
(12) Patent Application Publication
(10) Pub. No.: US 2023/0219568 A1
(43) Pub. Date: Jul. 13, 2023

(54) DIAGNOSTIC DEVICE FOR OTHER-VEHICLE BEHAVIOR PREDICTION AND DIAGNOSTIC METHOD FOR OTHER-VEHICLE BEHAVIOR PREDICTION

(71) Applicant: Mitsubishi Electric Corporation, Tokyo (JP)

(72) Inventor: Takuya TANIGUCHI, Tokyo (JP)

(73) Assignee: Mitsubishi Electric Corporation, Tokyo (JP)

(21) Appl. No.: 18/015,751

(22) PCT Filed: Nov. 2, 2020
(86) PCT No.: PCT/JP2020/041010

§ 371 Date: Jan. 12, 2023

(51) Int. Cl. B60W 30/095; B60W 40/04

(52) U.S. Cl. CPC B60W 30/0956; B60W 40/04; B60W 2554/4046; B60W 2554/80; B60W 2554/4041; B60W 2554/4042

(57) ABSTRACT

The present invention is configured to include an other-vehicle situation determination circuitry to estimate traveling situations of each of other vehicles traveling ahead of one's own vehicle and to determine that an alert situation is present when any of the other vehicles is estimated to be in a situation where a vehicle should slow down or change traffic lanes to a traffic lane in which one's own vehicle is traveling in order to avoid a collision with an object or a separate vehicle on a road; and a prediction function diagnosis circuitry, when receiving a determination result that the alert situation is present, diagnoses whether an other-vehicle behavior prediction function is sound or not based on whether or not an other-vehicle behavior prediction corresponding to the alert situation was able to be received from the other-vehicle behavior prediction function.

### TECHNICAL FIELD

The present application relates to a diagnostic device for other-vehicle behavior prediction and a diagnostic method for other-vehicle behavior prediction.

### BACKGROUND ART

In recent years, technologies such as Advanced Driver-Assistance Systems (ADAS) have been put to practical use to support driving in terms of collision prevention, preceding vehicle following control, traffic lane keeping control, etc. In such systems, an other-vehicle behavior prediction is necessary to accurately predict future behavior of other vehicles traveling around one's own vehicle. Thus, various methods have been proposed for predicting the behavior of other vehicles, including, for example, a prediction method using context-based prediction and a method for predicting the behavior of other vehicles by learning with neural networks, etc. (see, for example, Patent Documents 1 and 2).

### CITATION LIST

### Patent Document

Patent Document 1: Japanese Patent Application Publication Laid-open, No. 2015-215873 (Paragraphs 0045 to 0063, FIG. 3 to FIG. 5, Paragraphs 0065 to 0119)
Patent Document 2: Japanese Patent, No. 6074553 (Paragraphs 0184 to 0220, FIG. 16 to FIG. 22)

### SUMMARY OF INVENTION

### Problems to be Solved by Invention

However, the context-based prediction, which outputs the probability of a traic lane change on the basis of a certain rule, makes a prediction on the basis of a lot of information, including mainly the position, speed, and acceleration in a preceding vehicle and a vehicle traveling in an adjacent traffic lane. Meanwhile, since human makes a variety of decisions on traffic lane changes such as a lane change for branching into a desired road, a lane change for entering a service area, and a lane change for giving way to a vehicle behind, a large amount of information and complex calculations are involved in the prediction, thereby having a problem in terms of its accuracy.

In addition, behavior prediction by artificial intelligence, such as neural networks, is generally more accurate than an algorithm that makes a decision on the basis of a certain rule, and the prediction can be made with accuracy equal to or better than human decision. However, while accumulation of driving data for each of drivers is necessary for learning, the prediction accuracy decreases depending on a driver's condition, and the prediction accuracy is extremely low especially for a driver without the learning. That is, even in this case, although a large amount of information and complex calculations are involved in the prediction, thereby having a problem in terms of its accuracy.

The purpose of the present application is to disclose a technology to solve the above problems and to easily diagnose whether or not other-vehicle behavior prediction is working properly.

### Means for Solving Problems

A diagnostic device for other-vehicle behavior prediction disclosed in the present application diagnoses soundness of an other-vehicle behavior prediction function for predicting future behavior of other vehicles, and includes an other-vehicle situation estimation unit to estimate traveling situations of each of other vehicles traveling ahead of one's own vehicle from road information during traveling and information on positions of surrounding vehicles and objects that are obtained from a sensor and a locator, an alert situation determination unit to determine that an alert situation is present when any of the estimated traveling situations is in a situation where a vehicle should slow down or change traffic lanes to a traffic lane in which the one's own vehicle is traveling in order to avoid a collision with an object or a separate vehicle on a road, and a prediction function diagnosis unit, when receiving a determination result that the alert situation is present, diagnoses whether the other-vehicle behavior prediction function is sound or not depending on whether or not an other-vehicle behavior prediction corresponding to the alert situation was able to be received from the other-vehicle behavior prediction function.

A diagnostic method for other-vehicle behavior prediction disclosed in the present application diagnoses soundness of an other-vehicle behavior prediction function for predicting future behavior of other vehicles, and includes a step of estimating traveling situations of each of other vehicles traveling ahead of one's own vehicle from road information during traveling and information on positions of surrounding vehicles and objects that are obtained from a sensor and a locator, a step of determining that an alert situation is present when any of the estimated traveling situations is in a situation where a vehicle should slow down or change traffic lanes to a traffic lane in which the one's own vehicle is traveling in order to avoid a collision with an object or a separate vehicle on a road, and a step of diagnosing, when receiving a determination result that the alert situation is present, whether the other-vehicle behavior prediction function is sound or not depending on whether or not an other-vehicle behavior prediction corresponding to the alert situation was able to be received from the other-vehicle behavior prediction function.

### Effect of Invention

According to the diagnosis device for the other-vehicle behavior prediction or the diagnosis method for the other-vehicle behavior prediction disclosed in the present application, the soundness of the other-vehicle behavior prediction function is determined depending on whether or not a prediction corresponding to a situation is made, the situation being that when another vehicle needs to slow down or change traffic lanes.

That is, an object thereof is to provide a method for easily diagnosing whether or not the other-vehicle behavior prediction is working properly.

### BRIEF DESCRIPTION OF DRAWINGS

FIG. 1 is a block diagram showing a configuration of a diagnostic device for other-vehicle behavior prediction.

FIG. 2A to FIG. 2D each are schematic diagrams for explaining typical examples of alert patterns of determination objects that determines whether or not an alert situation is present in an other-vehicle behavior prediction device or an other-vehicle behavior prediction method according to Embodiment 1.

FIG. 3 is a flowchart showing an operation of the diagnostic device for the other-vehicle behavior prediction or an other-vehicle behavior prediction method.

FIG. 4 is a block diagram showing an example of a hardware configuration of the other-vehicle behavior prediction device.

Modes for Carrying Out Invention

### Embodiment 1

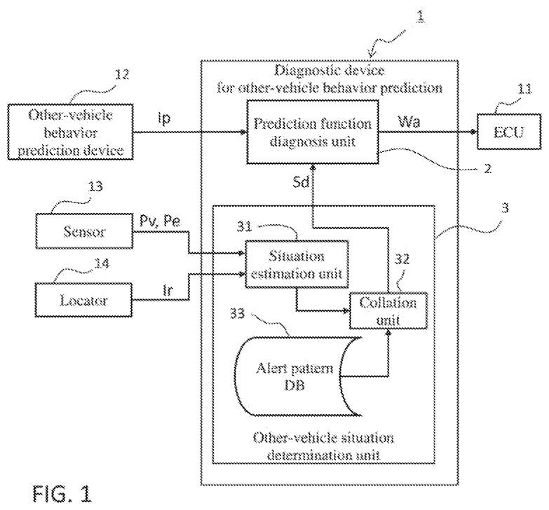

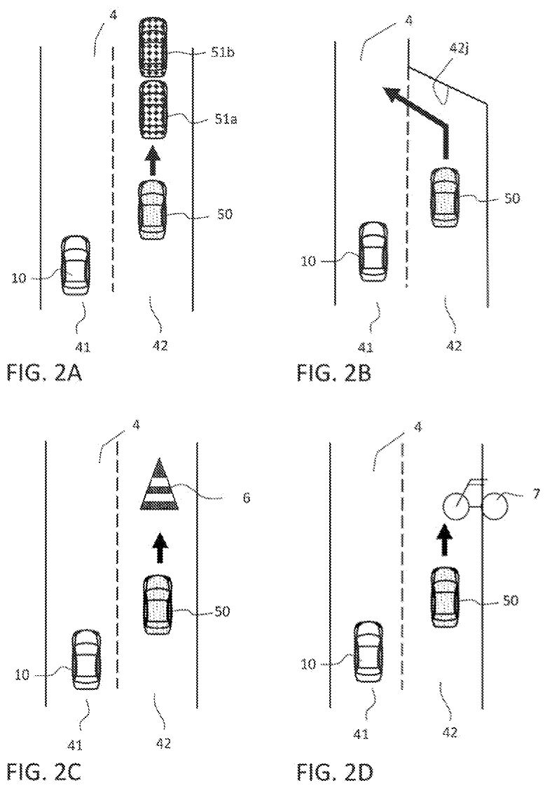

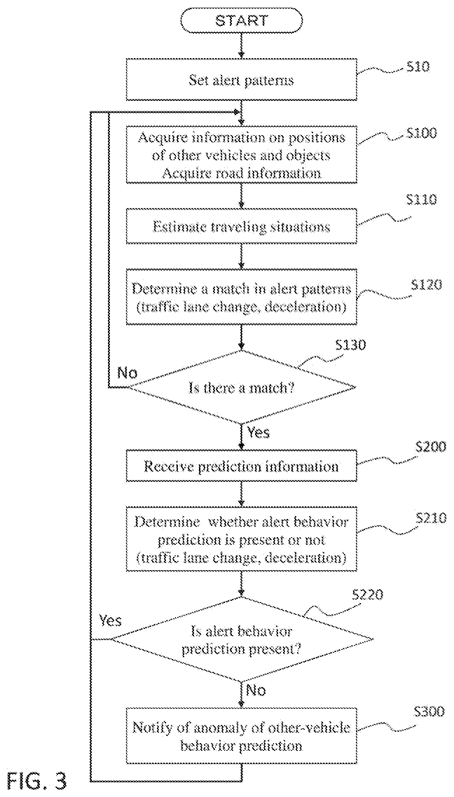

FIG. 1 to FIG. 3 are diagrams for explaining other-vehicle behavior prediction device or an other-vehicle behavior prediction method according to Embodiment 1. FIG. 1 is a block diagram showing the other-vehicle behavior prediction device together with other in-vehicle devices that exchange information therewith. FIG. 2A to 2D each show typical examples of alert patterns of determination objects that determine whether or not an alert situation is present, the alert patterns being to occur during traveling on a road with two traffic lanes, in the other-vehicle behavior prediction device or the other-vehicle behavior prediction method. FIG. 3 is a flowchart showing an operation of a diagnostic device for other-vehicle behavior prediction or the method for the other-vehicle behavior prediction.

The diagnosis device 1 for the other-vehicle behavior prediction according to Embodiment 1 of the present application, as shown in FIG. 1, diagnoses whether or not an other-vehicle behavior prediction device 12 is outputting a corresponding prediction information Ip in the situation where the traveling of the vehicle (one's own vehicle) in which the device is installed is obstructed by another vehicle. For this purpose, the diagnosis device 1 for the other-vehicle behavior prediction is provided with an other-vehicle situation determination unit 3 that determines whether or not an alert situation is present in which another vehicle may obstruct the traveling of one's own vehicle, and a prediction function diagnosis unit 2 diagnoses whether or not the prediction function is sound by checking whether or not the prediction information Ip is outputted from the other-vehicle prediction device 12 during the alert situation.

The other-vehicle situation determination unit 3 includes a situation estimation unit 31 that estimates situations of other vehicles, an alert pattern database 33 (abbreviated as DB in the figure) in which alert situations or situation patterns (alert patterns) are stored, and a collation unit 32 that collates whether an estimated situation matches any of the alert patterns or not.

The situation estimation unit 31 is configured to estimate traveling situations of other vehicles located ahead of one's own vehicle on the basis of other-vehicle position information Pv and object position information Pe obtained from a sensor 13, and road information Ir obtained from a locator 14. The other-vehicle position information Pv is information on positions of other vehicles ahead of and around one's own vehicle, and the object position information Pe is information on positions of objects including obstacles. In addition, the road information Ir is information on a location and a shape (route in particular) of a road on which the vehicle is traveling, obtained from a measured self-position and a map.

The sensor 13 is assumed to be any of a millimeter wave radar, a camera, and a laser radar capable of recognizing objects ahead of and around a vehicle or to be configured with a combination of these sensors to output an integrated recognition result. The locator 14 is assumed to be a device that recognizes a location and a shape of a road on which a vehicle is traveling using a road map from a self-position, the self-position being measured using a range finding technology for the self-position such as a global positioning satellite system.

The alert pattern database 33 stores the alert patterns, which are alert situations involving a collision that occurs if another vehicle traveling around one's own vehicle does not change traffic lanes to the traveling traffic lane of one's own vehicle or does not slow down. Note that the alert patterns are not limited to those stored in advance, and may be configured to be updated via a communication path (not shown) or via machine learning and the like.

The collation unit 32 collates a traveling situation of another vehicle estimated by the situation estimation unit 31 with the alert patterns stored in the alert pattern database 33, and determines whether or not another vehicle is in the above-described alert situation (later described in detail). When it is determined that the alert situation is present, an alert signal Sd is output to the prediction function diagnosis unit 2.

When the alert signal Sd is received from the other vehicle situation determination unit 3, the prediction function diagnosis unit 2 diagnoses whether or not the other-vehicle behavior prediction device or the prediction function is sound depending on whether or not the prediction information Ip having the contents corresponding to the alert signal Sd is output from the other-vehicle behavior prediction device 12. When the prediction information Ip corresponding to the alert signal Sd is not output, it is diagnosed that an anomaly has occurred in the other-vehicle behavior prediction device 12, the prediction function, or the transmission path, and a warning signal Wa indicating an occurrence of the anomaly is notified to a control device of one's own vehicle such as an electronic control unit (ECU11). As a result, it is possible to notify the driver, a system administrator, or the like that the anomaly has occurred in the other-vehicle behavior prediction device 12, the prediction function, or the transmission path in one's own vehicle.

Note that the other-vehicle behavior prediction device 12 to be diagnosed predicts a future behavior associated with a driver's determination as described in, for example, Patent Document 1 or Patent Document 2. This is different from the situation estimation unit 31 of the present application that determines whether or not the traveling state can be maintained on the basis of the road situation and the traveling state of the vehicle.

Then, prior to the description of the operation, typical estimation examples (alert patterns) in which the traveling state cannot be maintained will be described in order to show a level of the estimation in the situation estimation unit 31 and the alert patterns to be set. In FIG. 2, it is assumed that one's own vehicle 10 is traveling in a traffic lane 41 on a road 4 having two traffic lanes, namely, the traffic lane 41 and the traffic lane 42, and a determination object for determining whether or not the traveling state can be maintained is another vehicle 50 traveling ahead of one's own vehicle 10 in the adjacent traffic lane 42.

Alert Pattern 1

An alert pattern 1 is a case where, as shown in FIG. 2A, there are vehicles 51a and 51b ahead in the traffic lane 42 in which another vehicle 50 is traveling, the vehicles 51a and 51b being slower than another vehicle 50 or being stopped. In the road information Ir, this corresponds to a pattern (route pattern) in which the traffic lane 42 adjacent to the traffic lane of one's own vehicle (traffic lane 41) extends in parallel with one's own traffic lane in the forward traveling direction on the road 4 on which one's own vehicle 10 is currently traveling. Further, in the other-vehicle position information Pv, this corresponds to a pattern (road situation pattern) in which another vehicle 50 are present ahead in the adjacent other traffic lane (traffic lane 42) and the vehicles 51a and 51b that are slower than another vehicle 50 or stopped are present further ahead of another vehicle 50.

When such a situation is detected, another vehicle 50 traveling in the traffic lane 42 adjacent to the traffic lane 41 in which one's own vehicle 10 is traveling will collide with the preceding vehicles 51a unless it changes traffic lanes to the traffic lane 41 or slows down in the traffic lane 42. In other words, it is determined that the current traveling state cannot be maintained, and thus the current traveling state matches an alert pattern. At this time, the relative speed and the distance between another vehicle 50 and the vehicle 51a may be added to a criterion for determining whether or not another vehicle 50 matches the alert pattern in which speed reduction accompanied by deceleration equal to or greater than a certain threshold value is required.

Alert Pattern 2

As shown in FIG. 2B, an alert pattern 2 is a case where there is a merging point 42j ahead of another vehicle 50 into the traffic lane 41; that is, a road situation where the traveling traffic lane (traffic lane 42) of another vehicle 50 merges with the traffic lane of one's own vehicle (traffic lane 41). In the road information Ir, this corresponds to a route pattern in which the traffic lane 42 adjacent to the traffic lane of one's own vehicle (traffic lane 41) extends forward in the traveling direction in the road 4 on which one's own vehicle 10 is currently traveling, and the adjacent traffic lane 42 has the merging point 42j ahead in which it merges with the traffic lane 41. Further, in the other-vehicle position information Pv, this corresponds to a road situation pattern in which another vehicle 50 is present ahead in the adjacent traffic lane 42.

When such a situation is detected, it is determined that another vehicle 50 matches an alert pattern in which it has to change traffic lanes to the traffic lane 41 or has to slow down. In this case as well, for example, the speed of another vehicle 50 and the distance to the merging point 42j may be added to the criterion for determining whether or not another vehicle 50 matches the alert pattern in which speed reduction accompanied by deceleration equal to or greater than a certain threshold value is required.

Alert Pattern 3

An alert pattern 3 is a case where there is a static obstacle 6 such as a person or an object on the traveling traffic lane (traffic lane 42) of another vehicle 50 as shown in FIG. 2C. In the road information Ir, this corresponds to the road 4 on which one's own vehicle 10 is currently traveling is a route pattern in which the traffic lane of one's own vehicle (traffic lane 41) and the adjacent traffic lane 42 extend in parallel with each other ahead in the traveling direction. Further, in the other-vehicle position information Pv and the object position information Pe, this corresponds to a road situation pattern in which another vehicle 50 is present ahead in the adjacent traffic lane 42 and the obstacle 6 is present further ahead of another vehicle 50.

When such a situation is detected, it is determined that another vehicle 50 whose traveling state cannot be continued owing to the obstacle 6 matches an alert pattern in which it has to change traffic lanes to the traffic lane 41 or has to slow down. Also in this case, the distance between another vehicle 50 and the obstacle 6 and the speed of another vehicle 50 may be added to the criterion for determining whether or not another vehicle 50 matches the alert pattern in which speed reduction accompanied by deceleration equal to or greater than a certain threshold value is required.

Alert Pattern 4

An alert pattern 4 is a case where, as shown in FIG. 2D, when a dynamic object 7 (person, vehicle) is rushing into the traveling traffic lane (traffic lane 42) of another vehicle 50, another vehicle 50 should change traffic lanes to the traffic lane 41 or should slow down. In the road information Ir, the road 4 on which the one's own vehicle 10 is currently traveling corresponds to a route pattern in which the traffic lane of one's own vehicle (traffic lane 41) and the adjacent traffic lane 42 extend in parallel with each other ahead in the traveling direction. Further, in the other-vehicle position information Pv and the object position information Pe, this corresponds to a detected road situation pattern such that another vehicle 50 is present ahead in the adjacent traffic lane 42 and the dynamic object 7 further ahead such as a bicycle rushes into so as to cross the traffic lane 42.

When such a situation is detected, it is determined that another vehicle 50 whose traveling state cannot be continued owing to the front crossing of the dynamic object 7 matches the alert pattern in which it has to change traffic lanes to the traffic lane 41 or has to slow down. At this time, for example, the distance between another vehicle 50 and the position into which the dynamic object 7 has rushed and the speed of another vehicle 50 may be added to the criterion for determining whether or not another vehicle 50 matches the alert pattern in which speed reduction accompanied by deceleration equal to or greater than a certain threshold value is required.

The above-described four patterns are typical examples, and the situations (estimation contents) that can be determined to be the alert patterns are not limited thereto. On the other hand, as shown in the typical example, the estimation objects are “situations” indicating whether or not the alert situation of collision or contact or the like is present unless another vehicle 50 traveling ahead of one's own vehicle 10 slows down or changes traffic lanes to the traffic lane of one's own vehicle (traffic lane 41), and these are different in nature from “predictions” in the behavior prediction. That is, since the future behavior is not predicted but the situation for determining whether or not another vehicle 50 ahead can maintain the current traveling state is only estimated, the number of data, hierarchical structure, and the like required for the calculation are much simpler than the behavior prediction. Therefore, although advanced prediction such as the future behavior prediction cannot be performed, the possibility of occurrence of an error is reduced, and soundness of the behavior prediction can be easily diagnosed.

On the basis of the above-described configuration, the operation of the diagnosis device 1 for the other-vehicle behavior prediction and the diagnostic method for the other-vehicle behavior prediction will be described with reference to the flowchart of FIG. 3. Although processes after the start of the operation is described in the flow, the alert patterns are basically set before the diagnosing device 1 for the other-vehicle behavior prediction is mounted or installed (formed) (step S10), and are assumed to be stored in the alert pattern database 33 before the start. Of course, as described above, it is possible to receive appropriate correction and adjustment by learning during the operation.

The situation estimation unit 31 acquires the other-vehicle position information Pv and the object position information Pe from the sensor 13, and acquires the road information Ir from the locator 14 (step S100). Then, on the basis of the acquired information, the traveling situation (route pattern and road situation pattern) of each of other vehicles is estimated from the positions of the other vehicles and the positions and shapes of the obstacle and the road (step S120), and is transmitted to the collation unit 32.

The collation unit 32 collates the estimated traveling situation with the alert patterns stored in the alert pattern database 33, and determines whether or not the traveling situation matches a pattern, that is, whether or not an alert situation is present in which a vehicle has to change traffic lanes or has to slow down in the estimated traveling situation (step S120).

When it is determined that “there is no match” (“No” in step S130), the process returns to step S00. On the other hand, when it is determined that “there is a match” (“Yes” in step S130), the process proceeds to a diagnostic step for the other-vehicle behavior prediction in step S200 and thereafter.

In the diagnostic step for the other-vehicle behavior prediction, first, the prediction information Ip is acquired from the other-vehicle behavior prediction device 12 (step S200). Then, it is determined whether or not an alert behavior prediction of changing the traffic lanes or decelerating in the traveling situation of another vehicle determined to match the alert pattern is included in the acquired prediction information Ip (step S210).

When the alert behavior prediction is not included (“No” in step S220), it means that the prediction of changing the traffic lanes or decelerating is not made in spite of the alert situation, and the warning signal Wa indicating that the other-vehicle behavior prediction is anomalous is issued to notify that the an anomaly has occurred in the other-vehicle behavior prediction (step S300). In a case where the alert behavior prediction is included (“Yes” in step S220), it means that the prediction of changing the traffic lane or decelerating corresponding to the alert pattern is made, and thus there is no anomaly in the other-vehicle behavior prediction (diagnosed to be normal), and the process returns to step S100.

Note that a situation that is assumed to be unpredicted by the other-vehicle behavior prediction device 12 may not be included as a diagnosis target in its usage. For example, a diagnosis item may be selected in accordance with a model of the other-vehicle behavior prediction device or a type of prediction function by associating each of the alert patterns with data on the presence or absence of collation targets depending on the corresponding other-vehicle behavior prediction device or the like.

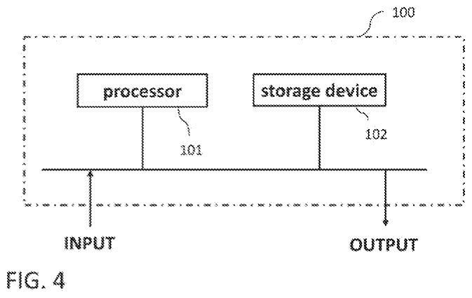

Note that the prediction function diagnosis unit 2 and the other-vehicle situation determination unit 3 constituting the diagnosis device 1 for the other-vehicle behavior prediction according to Embodiment 1 can be represented by a configuration of one piece of hardware 100 including a processor 101 and a storage device 102 as shown in FIG. 4. Although not shown, the storage device 102 includes a volatile storage device such as a random access memory, and a nonvolatile auxiliary storage device such as a flash memory. Instead of the flash memory, an auxiliary storage device such as a hard disk may be provided. The processor 101 executes a program inputted from the storage device 102. In this case, the program is inputted from the auxiliary storage device to the processor 101 via the volatile storage device. In addition, the processor 101 may output data such as a calculation result to the volatile storage device of the storage device 102 or may store the data in the auxiliary storage device via the volatile storage device.

Note that, although various exemplary embodiments and examples are described in the present application, various features, aspects, and functions described in the embodiments are not limited to the exemplifications and can be applicable alone or in their various combinations to each embodiment. Accordingly, countless variations that are not illustrated are envisaged within the scope of the art disclosed herein. For example, the case where at least one component is modified, added or omitted, and further the case where at least one component is extracted and combined with another component are included.

For example, in the present example, whether or not the alert situation is present is determined on the basis of whether or not another vehicle situation estimated by the situation estimation unit 31 matches any of the alert patterns stored in the alert pattern database 33, but the present invention is not limited thereto. For example, the situation estimation unit 31 may directly determine whether or not another vehicle is in a situation in which it should slow down or change traffic lanes to the traffic lane of one's own vehicle (traffic lane 41). Since this is estimation of a situation different from the future behavior prediction, it can be executed with a simple algorithm.

The diagnosis device 1 for the other-vehicle behavior prediction to be diagnosed is not necessarily mounted on one's own vehicle 10, and may be obtained from an outside such as a cloud server. Further, the behavior prediction is not limited to the contents described in Patent Document 1 or 2, and the device may have a more advanced or diverse behavior prediction functions. Needless to say, the alert patterns are not limited to the case with two traffic lanes, but may be a case with one traffic lane or three or more traffic lanes.

As described above, the diagnostic device 1 for other-vehicle behavior prediction according to Embodiment 1 diagnoses soundness of an other-vehicle behavior prediction function (for example, other-vehicle behavior prediction device 12) for predicting future behavior of other vehicles, and includes the other-vehicle situation estimation unit (situation estimation unit 31) to estimate the traveling situations of each of other vehicles 50 traveling ahead of one's own vehicle 10 from the road information Ir during traveling and the information on positions of surrounding vehicles and objects (other-vehicle position information Pv, object position information Pe) that are obtained from a sensor 13 and a locator 14, the alert situation determination unit (collation unit 32, alert pattern database 33) to determine that the alert situation is present when any of the estimated traveling situations is in the situation where a vehicle should slow down or change traffic lanes to the traffic lane 41 in which the one's own vehicle 10 is traveling in order to avoid a collision with an object or a separate vehicle on the road 4, and the prediction function diagnosis unit 2, when receiving a determination result that the alert situation is present, diagnoses whether the other-vehicle behavior prediction function (for example, other-vehicle behavior prediction device 12) is sound or not depending on whether or not an other-vehicle behavior prediction corresponding to the alert situation was able to be received from the other-vehicle behavior prediction function (for example, other-vehicle behavior prediction device 12). Therefore it is possible to easily diagnose whether or not the other-vehicle behavior prediction is working properly.

In particular, when the alert pattern database 33 is provided to store a combination of a route of the road 4 and road situations ahead as the alert patterns, the route of the road being supposed to be in a situation in which a second vehicle (corresponding to another vehicle 50) traveling ahead of a first vehicle (corresponding to one's own vehicle 10) should slow down or change traffic lanes to the traffic lane 41 in which the first vehicle is traveling in order to avoid a collision with an object or a separate vehicle on the road 4, and the other-vehicle situation determination unit 3 (collation unit 32) is configured to determine whether or not the alert situation is present depending on whether or not an estimated traveling situation (by situation estimation unit 31) matches any of the alert patterns, it is possible to easily diagnose whether or not the other-vehicle behavior prediction is working properly with a simple computation.

In particular, when the alert pattern database 33 is configured to store at least any of the following cases as the alert patterns: a case where there is a vehicle (for example, vehicle 51a, vehicle 51b) ahead of the second vehicle (corresponding to another vehicle 50) that is slower than the second vehicle or is stopped (alert pattern 1); a case where there is a merging point ahead of the second vehicle into the traffic lane 41 in which the first vehicle (one's own vehicle 10) is traveling (alert pattern 2); a case where there is the obstacle 6 ahead of the second vehicle (alert pattern 3); and a case where the dynamic object 7 intruding ahead of the second vehicle (alert pattern 4) is detected, it is possible to easily and reliably determine whether or not a typical alert situation is present.

In addition, when the alert situation determination unit (collation unit 32) is configured to determine whether or not the alert situation is present depending on whether or not deceleration required for the slowdown exceeds a threshold value at the time when a traveling situation corresponding to the situation in which a vehicle should slow down is to be determined, it is possible to determine whether or not the situation is in the alert situation in a manner more effective in the actual situation.

When the alert situation determination unit (collation unit 32) is configured to exclude situations that are not subject to the prediction in the other-vehicle behavior prediction function (for example, other-vehicle behavior prediction device 12) from determination targets on whether or not the alert situation is present, it is possible to prevent a situation that is not to be predicted by the other-vehicle behavior prediction function from being erroneously determined to be anomalous.

As described above, the diagnostic method for other-vehicle behavior prediction according to Embodiment 1 is the method to diagnose soundness of an other-vehicle behavior prediction function (for example, other-vehicle behavior prediction device 12) for predicting future behavior of other vehicles, and is configured to include the step of estimating the traveling situations of each of other vehicles 50 traveling ahead of one's own vehicle 10 from road information Ir during traveling and information on positions of surrounding vehicles and objects (other-vehicle position information Pv, object position information Pe) that are obtained from the sensor 13 and the locator 14 (steps S100 to S110); the step of determining that the alert situation is present when any of the estimated traveling situations is in a situation where a vehicle should slow down or change traffic lanes to a traffic lane 41 in which the one's own vehicle 10 is traveling in order to avoid a collision with an object or a separate vehicle on the road 4 (steps S120 to S130); and the step of diagnosing, when receiving a determination result that the alert situation is present, whether the other-vehicle behavior prediction function (for example, other-vehicle behavior prediction device 12) is sound or not depending on whether or not an other-vehicle behavior prediction corresponding to the alert situation was able to be received from the other-vehicle behavior prediction function (for example, other-vehicle behavior prediction device 12) (steps S200 to S300), so that it is possible to easily diagnose whether or not the other-vehicle behavior prediction function is working properly.

In particular, a combination of a route of the road 4 and road situations ahead is set as the alert patterns (step S10), the route of the road being supposed to be in the situation in which the second vehicle (corresponding to another vehicle 50) traveling ahead of the first vehicle (corresponding to one's own vehicle 10) should slow down or change traffic lanes to a traffic lane 41 in which the first vehicle is traveling in order to avoid a collision with an object or a separate vehicle on the road 4, and in the step of determining the alert situation, when whether or not the alert situation is present is configured to be determined depending on whether or not an estimated traveling situation matches any of the alert patterns, it is possible to easily diagnose whether or not the other-vehicle behavior prediction is working properly with a simple computation.

In particular, in the step of setting the alert patterns (step S10), at least any of the following cases is configured to be set into the alert patterns: the case where there are vehicles 51a, 51b that are ahead of another vehicle 50 and are slower than said another vehicle or are stopped; the case where there is the merging point 42j ahead of said another vehicle into the traffic lane (traffic lane 41) in which the first vehicle is traveling; the case where there is the obstacle 6 ahead of another vehicle 50; and the case where the dynamic object 7 intruding ahead of another vehicle 50 is detected. Therefore, it is possible to easily and reliably determine whether or not the situation is a typical alert situation.

### DESCRIPTION OF REFERENCE NUMERALS AND SIGNS

1: diagnostic device for other-vehicle behavior prediction. 10: one's own vehicle, 11: ECU, 12: other-vehicle behavior prediction device, 13 sensor, 14: locator, 2: prediction function diagnostic unit. 3: other-vehicle situation determination unit, 31: situation estimation unit, 32: collation unit (alert situation determination unit), 33: alert pattern database (alert situation determination unit), 4: road, 41: traffic lane, 42: traffic lane, 42j: merging point, 50: another vehicle 6: obstacle, 7: dynamic object, Ip: prediction information, Ir: road information, Pe: object position information, Pv: other-vehicle position information, Sd: alert signal, Wa: Warning signal.

1-5. (canceled)

6. A diagnostic method for other-vehicle behavior prediction that diagnoses soundness of an other-vehicle behavior prediction function for predicting future behavior of other vehicles, the diagnostic method comprising:
estimating traveling situations of each of other vehicles traveling ahead of one's own vehicle from road information during traveling and information on positions of surrounding vehicles and objects that are obtained from a sensor and a locator;
determining that an alert situation is present when any of the estimated traveling situations is in a situation where a vehicle should slow down or change traffic lanes to a traffic lane in which the one's own vehicle is traveling in order to avoid a collision with an object or a separate vehicle on a road; and
diagnosing, when receiving a determination result that the alert situation is present, whether the other-vehicle behavior prediction function is sound or not depending on whether or not an other-vehicle behavior prediction corresponding to the alert situation was able to be received from the other-vehicle behavior prediction function.

7. The diagnostic method for the other-vehicle behavior prediction according to claim 6, wherein
a combination of a route of the road and road situations ahead is set as alert patterns, the route of the road being supposed to be in a situation in which a second vehicle traveling ahead of a first vehicle should slow down or change traffic lanes to a traffic lane in which the first vehicle is traveling in order to avoid a collision with an object or a separate vehicle on the road, and
the determining includes determination on whether or not the alert situation is present depending on whether or not an estimated traveling situation matches any of the alert patterns.

8. A diagnostic device for other-vehicle behavior prediction that diagnoses soundness of an other-vehicle behavior prediction function for predicting future behavior of other vehicles, the diagnostic device comprising:
an other-vehicle situation estimation circuitry to estimate traveling situations of each of other vehicles traveling ahead of one's own vehicle from road information during traveling and information on positions of surrounding vehicles and objects that are obtained from a sensor and a locator;
an alert situation determination circuitry to determine that an alert situation is present when any of the estimated traveling situations is in a situation where a vehicle should slow down or change traffic lanes to a traffic lane in which the one's own vehicle is traveling in order to avoid a collision with an object or a separate vehicle on a road; and
a prediction function diagnosis circuitry, when receiving a determination result that the alert situation is present, diagnoses whether the other-vehicle behavior prediction function is sound or not depending on whether or not an other-vehicle behavior prediction corresponding to the alert situation was able to be received from the other-vehicle behavior prediction function.

9. The diagnostic device for the other-vehicle behavior prediction according to claim 8, wherein
an alert pattern database is provided to store a combination of a route of the road and road situations ahead as alert patterns, the route of the road being supposed to be in a situation in which a second vehicle traveling ahead of a first vehicle should slow down or change traffic lanes to a traffic lane in which the first vehicle is traveling in order to avoid a collision with an object or a separate vehicle on the road, and
the alert situation determination circuitry determines whether or not the alert situation is present depending on whether or not an estimated traveling situation matches any of the alert patterns.

10. The diagnostic device for the other-vehicle behavior prediction according to claim 9, wherein
the alert pattern database stores at least any of the following cases as the alert patterns:
a case where there is a vehicle ahead of the second vehicle that is slower than the second vehicle or is stopped; a case where there is a merging point ahead of the second vehicle into the traffic lane in which the first vehicle is traveling; a case where there is an obstacle ahead of the second vehicle; and a case where a dynamic object intruding ahead of the second vehicle is detected.

11. The diagnostic device for the other-vehicle behavior prediction according to claim 8, wherein the alert situation determination circuitry determines whether or not the alert situation is present depending on whether or not deceleration required for the slowdown exceeds a threshold value at a time when a traveling situation corresponding to the situation in which a vehicle should slow down is to be determined.

12. The diagnostic device for the other-vehicle behavior prediction according to claim 9, wherein the alert situation determination circuitry determines whether or not the alert situation is present depending on whether or not deceleration required for the slowdown exceeds a threshold value at a time when a traveling situation corresponding to the situation in which a vehicle should slow down is to be determined.

13. The diagnostic device for the other-vehicle behavior prediction according to claim 10, wherein the alert situation determination circuitry determines whether or not the alert situation is present depending on whether or not deceleration required for the slowdown exceeds a threshold value at a time when a traveling situation corresponding to the situation in which a vehicle should slow down is to be determined.

14. The diagnostic device for the other-vehicle behavior prediction according to claim 8, wherein the alert situation determination circuitry excludes situations that are not subject to prediction in the other-vehicle behavior prediction function from determination targets on whether or not the alert situation is present.

15. The diagnostic device for the other-vehicle behavior prediction according to claim 9, wherein the alert situation determination circuitry excludes situations that are not subject to prediction in the other-vehicle behavior prediction function from determination targets on whether or not the alert situation is present.

16. The diagnostic device for the other-vehicle behavior prediction according to claim 10, wherein the alert situation determination circuitry excludes situations that are not subject to prediction in the other-vehicle behavior prediction function from determination targets on whether or not the alert situation is present.

17. The diagnostic device for the other-vehicle behavior prediction according to claim 11, wherein the alert situation determination circuitry excludes situations that are not subject to prediction in the other-vehicle behavior prediction function from determination targets on whether or not the alert situation is present.

18. The diagnostic device for the other-vehicle behavior prediction according to claim 12, wherein the alert situation determination circuitry excludes situations that are not subject to prediction in the other-vehicle behavior prediction function from determination targets on whether or not the alert situation is present.

19. The diagnostic device for the other-vehicle behavior prediction according to claim 13, wherein the alert situation determination circuitry excludes situations that are not subject to prediction in the other-vehicle behavior prediction function from determination targets on whether or not the alert situation is present.
